(19) United States
(12) Patent Application Publication
(10) Pub. No.: US 2011/0125998 A1
(43) Pub. Date: May 26, 2011

(54) NETWORK PHOTOGRAPHING APPARATUS HAVING A PARTIAL ENCRYPTION FUNCTION

(75) Inventors: Yong-Sung JEON, Daejeon (KR); Moo-Seop Kim, Daejeon (KR); Young-Sae Kim, Daejeon (KR); Jong-Wook Han, Daejeon (KR); Hyun-Sook Cho, Daejeon (KR); Geon-Woo Kim, Daejeon (KR); Hong-II Ju, Daejeon (KR); Jin-Hee Han, Daejeon (KR); Su-Gil Choi, Daejeon (KR)

(73) Assignee: ELECTRONICS AND TELECOMMUNICATIONS RESEARCH INSTITUTE, Daejeon-city (KR)

(21) Appl. No.: 12/838,578

(22) Filed: Jul. 19, 2010

(30) Foreign Application Priority Data
Nov. 25, 2009 (KR) 10-2009-0114720

(51) Int. Cl. H04L 29/06

(52) U.S. Cl. 713/150

(57) ABSTRACT

Disclosed is a network photographing apparatus including a partial encryption function capable of encrypting only a portion of objects included in images. A network photographing apparatus including a partial encryption function, includes an object information extracting unit that receives digital image data from a photographing unit, analyzes a plurality of objects included in the digital image data, and generates object information data; an image compressing unit that processes the digital image data with compression data; and an encryption unit that searches encryption target object information data among the object information data received from the object information extracting unit and generates and sends out the encrypted compression data by encrypting only a part of the compression data, the part corresponding to the encryption target object information data.

### CROSS REFERENCE TO RELATED APPLICATIONS

This application claims priority to Korean Patent Application No. 10-2009-00114720 filed on Nov. 25, 2009, the entire contents of which are herein incorporated by reference.

### BACKGROUND OF THE INVENTION

1. Field of the Invention

The present invention relates to an encryption technology in a network photographing apparatus such as camera. More particularly, the present invention relates to a network photographing apparatus recognizing a portion of images photographed by the network photographing apparatus as an object and including a partial encryption technology encrypting only the portion of images by applying the encryption function to each object.

2. Description of the Related Art

Recently, a research on an information sharing technology between users has been actively conducted due to the Internet blog, activation of community, etc. In particular, a new type of sharing activity combining information with contents, not simple information sharing on the Internet has rapidly increased due to the activation of user created contents (UCC), a local information site, a famous restaurant recommendation site, etc. The users combine their own experience or recommended information with simple character information as well as multimedia contents such as substantial pictures, moving pictures, etc., for the information so that they upload the combined information onto the site or let any users share the combined information, thereby forming a social network and communicating with the users.

According to the contents sharing type on theinternet, a research on the sharing technology for the multimedia contents among the above-mentioned information sharing technologies has been actively conducted. Among others, a technology of transmitting images such as pictures photographed by the user to the network in real time has increased. The users can directly download their own photographing images from the photographing apparatus to their own computer, etc., and directly upload them from the photographing apparatus to the network such as an Internet site, etc., through a communication networks when a path to upload is set, immediately when a photograph is taken, or when the user wants, without uploading the images onto the specific Internet site.

The network photographing apparatus has come into the limelight as a new technology. As a representative technology, there is a network camera that adds a communication function to a digital camera and immediately uploads images photographed by a camera onto a network via a wired and wireless communication network. By the network camera, the user directly uploads images from a camera to the Internet without stores the photographed images into the computer one by one and then, uploads the photographed images onto the Internet through a communication network.

The network photographing apparatus according to the related art includes an image sensor, a processor, a compressing module, a communication interface, and a storage medium and performs a function of simply compressing and transmitting obtained images. There is a photographing apparatus that recognizes specific objects, but even though the photographing apparatus recognizes the specific objects, it does not have any criteria for the recognition. Therefore, in the images photographed by the network photographing apparatus according to the related art, objects such as persons or the specific objects in the images are originally exposed to all the users that watch the images such that it cannot protect the image information or the user information.

### SUMMARY OF THE INVENTION

In order to solve the above problem, it is an object of the present invention to provide a network photographing apparatus that encrypts or removes portions of the images to be protected by the user or portions of images to be protected socially or legally among the images photographed by the user to facilitate the protection of personal information or classified information that can be easily distributed through a network. Further, it is an object of the present invention to provide a network photographing apparatus that can make definition and identification of an object clear when analyzing images and extracting objects of images and protect information with high accuracy.

In order to achieve the above object, according to an embodiment of the present invention, there is provided a network photographing apparatus including a partial encryption function, including: an object information extracting unit that receives digital image data from a photographing unit, analyzes a plurality of objects included in the digital image data, and generates object information data; an image compressing unit that processes the digital image data with compression data; and an encryption unit that searches encryption target object information data among the object information data received from the object information extracting unit and generates and sends out the encrypted compression data by encrypting only a part corresponding to the encryption target object information data of the compression data received from the image compressing unit.

There is provided a network photographing apparatus including a partial encryption function, including: a first processor that analyzes a plurality of objects included in digital image data received from a photographing unit and generates object information data; and a second processor that processes the digital image data into the compression data and searches encryption target object information data among the object information data received from the first processor and then generates and sends out encrypted compression data by encrypting only a part corresponding to the encryption target object information data of the compression data.

There is provided a network photographing method including a partial encryption function, including: generating object informationd data by analyzing a plurality of objects included in digital image data received from a photographing unit by an object information extracting unit; processing the digital image data with compression data by an image compression unit: searching encryption target object information data among the object information data received by the object information extracting unit by an encryption unit; and generating and sending out the encrypted compression data by encrypting only a part corresponding to the encryption target object information data of the compression data received from the image compressing unit by an encryption unit.

According to the present invention, a limitation which is that a camera cannot protect information of image can be prevented. In more detail, the present invention can protect object information, which is to be protected from being distributed on the network, by searching the object information including persons or objects and encrypting or removing the object information from the images. Further, the present invention clearly defines the objects to be searched and extracts the information on the searched objects and makes it into data in searching the object information, thereby clearly extracting the object information and improving the accuracy for the information protection.

### BRIEF DESCRIPTION OF THE DRAWINGS

FIG. 1 is a diagram showing a network photographing apparatus including a partial encryption function according to a first embodiment of the present invention;

FIG. 2 is a diagram showing a network photographing apparatus including a partial encryption function according to a second embodiment of the present invention;

FIG. 3 is a diagram showing a network photographing apparatus including a partial encryption function according to a third embodiment of the present invention;

FIG. 4 is a diagram showing a network photographing apparatus including a partial encryption function according to a fourth embodiment of the present invention;

FIG. 5 is a diagram showing an implementation example of the network photographing apparatus including the partial encryption function according to the first to fourth embodiments of the present invention; and

FIG. 6 is a flow chart of a photographing method using the network photographing apparatus including the partial encryption function according to the first to fourth embodiments of the present invention.

### DETAILED DESCRIPTION OF THE PREFERRED EMBODIMENTS

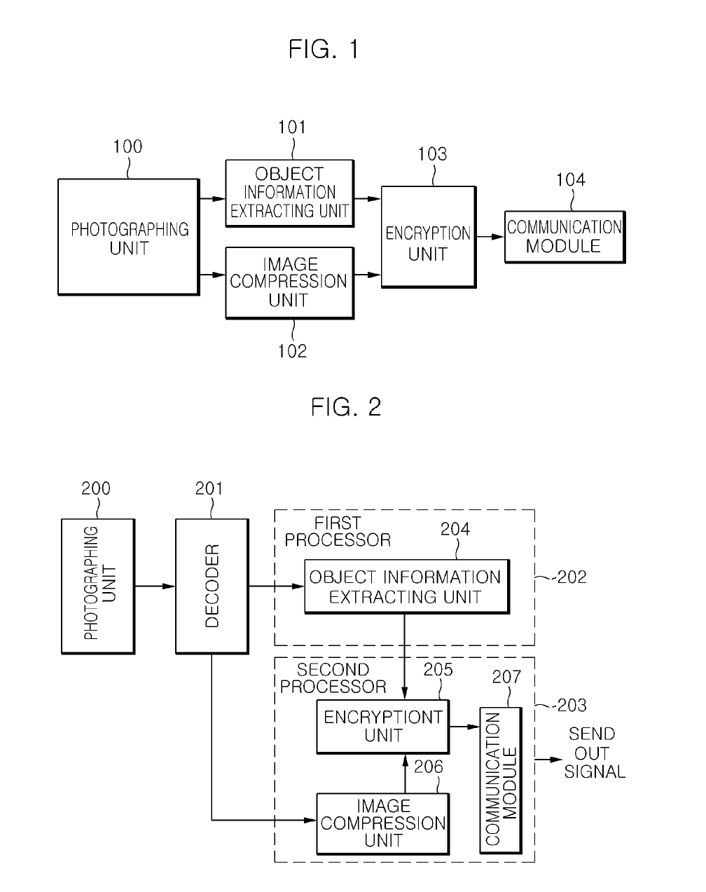

Hereinafter, a network photographing apparatus including a partial encryption function according to a first embodiment of the present invention will be described with reference to FIG. 1.

Referring to FIG. 1, a network photographing apparatus including a partial encryption function according to a first embodiment of the present invention includes an object information extracting unit 101. The object information extracting unit 101 receives digital image data for photographed images from a photographing unit 100 and analyzes the received digital image data. The object information extracting unit 101 analyzes the received digital image data, searches a plurality of objects included in the digital image data, makes information on the searched object into data, and performs a function of generating the object information data.

A photographing unit 100 means an apparatus that generates image data such as pictures, moving pictures, etc., which generally photographs the surrounding environment. According to the first embodiment of the present invention, the photographing unit 100 includes a digital camera that has been used generally. In addition to this, all the image photographing apparatuses such as a camera that can be installed in a portable computer, etc., may be the photographing unit 100.

According to the first embodiment of the present invention, the photographing unit 100 may include a decoder (not shown). The decoder serves to convert image signals photographed by the photographing unit 100 into digital image data. The photographing unit 100 converts and outputs optical signals photographed through a lens of a camera, etc., into electrical signals and the decoder included in the photographing unit 100 converts and processes analog signals into digital image data in a YCbCr type since the electrical image signals are the analog signals. The YCbCr is a kind of color space that is used in an image system. Y is luminance component and Cb and Cr are color difference component. The YCbCr is also called YCC. The YCbCr is not an absolute color space and is one of schemes that encode RGB information. Actually viewed image colors depend on the original RGB information that is used to display signals. The value represented by the YCbCr can be expected only when the standard RGB colors are used or when ICC profile to be used for converting colors is enclosed. In order to change signals into a digital format, the YCbCr signal prior to being subjected to scaling and offset adjusting steps is called YPbPr. In addition to the YCbCr type, it may be converted into data having a format such as YUV or RGB, etc.

As described above, the object information extracting unit 101 receives the digital image data for images photographed through the photographing unit 101 including the decoder. The object information extracting unit 100 analyzes the received digital image data and detects the objects, thereby generating the object information data.

The objects in the digital image data searched by the object information extracting unit 101 may be a person included in the digital image data according to the first embodiment of the present invention. Since the user can photograph his own or the other person at a specific place, etc., a portion of the images having a person, which actually reflects, personal information, such as the face or features of his own or the other person, and can be leaked, may be designated as an object. In addition to this, information that should not be leaked or made public among portions included in images when being photographed by the user or all the shapes that can be identified regardless of whether the information is made public may be included in the objects. For example, one or more objects among portions corresponding to a predetermined region (for example, division region above the left when the image is divided into 4) regardless of specific objects, buildings, specific colors, identifiable specific shapes, character information, and identifiable specific shapes or colors may be objects.

When the objects are detected, the object information data are generated by the object information extracting unit 101. The object information data means the information that can identify the above-mentioned objects. In the first embodiment of the present invention, at least one of the position, size, range, color, shape and a name of an object to identify the objects may be included in the object information data. Preferably, at least one of the position, size, range, color, and shape of the above-mentioned object is recognized as valuable information of the object and the name of the above-mentioned object may be used as the representative tag information. Through this, the encryption for each object to be mentioned below may also determine the target to be searched and protected or not based on the name of the object that is the tag information on the object.

When the function described above is performed in the object information extracting unit 101, the photographed digital image data are extracted as the object information data. When transmitting the digital image data from the photographing unit 100 to the object information extracting unit 101, the image compressing unit 102 that receives the digital image data together may be included in the network photographing apparatus including the partial encryption function of the present invention.

The image compressing unit 102 basically reduces the capacity of the digital image data and is converted into the compression data that compresses the digital image data into a usable format by the network and other users. The image compressing unit 102 serves to reduce the data amount that is consumed to basically express images. It is a main object of The image compressing unit 102 to deteriorate the original quality all the time by the characteristic of the image compressing technology. The compressed image efficiently reduces the bandwidth required to transmit the digital images through a cable, a terrestrial broadcast, and a satellite service. Most compression reduces capacity using the loss compression. In the embodiment of the present invention, the compression target image is a still picture and may selectively use the image compressing format in order to meet the used format of all the users. Therefore, the image compressing unit 102 may include a codec module necessary to compress images and the codec module may selectively use the format type for compressing the still picture. The still picture compressing format such as GIF, TIFF, or JPEG, etc., may be used. However, in addition to the still picture, moving pictures may be used, such that MPEG series format, H.261, or H.263, etc., may be used.

As described above, the digital image data are converted into the compression data in the image compressing unit 102 and is extracted into the object information data in the object information extracting unit 101. The encryption unit 103 that uses and processes the compression data and the object information data may also be included in the network photographing apparatus including the partial encryption function according to the first embodiment of the present invention.

The encryption unit 103 receives the object information data and the compression data from the image compressing unit 102 and the object information extracting unit 101. Therefore, the encryption unit 103 should be connected the object information extracting unit 101 and the image compressing unit 102 to simultaneously transmit and receive data. The encryption unit 103 combines the object information data with the compression data to encrypt or remove only the encryption target object information, thereby generating the finally encrypted compression data.

The encryption unit 103 first analyzes the object information data in order to perform the function. The object information data includes a plurality of information on the object extracted from the object information extracting unit 101 as described above and receives the information as data to search whether any objects are extracted. Therefore, in the first embodiment of the present invention, the encryption unit 103 may include the database in which the object information data on the object extracted up to now are stored. Through this, whether the object information data extracted from the current image means any object can be easily identified.

In addition, since the encryption unit 103 differentiates the object information data on objects to be protected among the identified object information data, it may further include a function of storing and updating an identification key (for example, name of an object as tag information) for the object list data or the object list data to be encrypted. A method of storing and updating the identification key for the object list data or the object list data to be encrypted may be designating the object list data that will be directly protected by the user and may be storing and updating the object list data list or the tag information list that will be publicly protected after receiving it through the network. The encryption unit 103 compares the object information data stored in the storage unit in the encryption unit 103 and which can be stored and encrypted with the object information data received from the object information extracting unit 101 to determine whether the identified object information data mean any object and to determine whether the object represented by the received object information data is an object to be protected. Through this, if there is the object information data to be encrypted among the received object information data, the encryption unit 103 divides only the object information data to be protected, that is, to be encrypted and encrypts parts of the compression data corresponding thereto. If so, the encryption unit 103 processes the compression data (digital image data) received through the photographing unit 100 and the image compressing unit 102, thereby generating the encryption compression data which the specific object to be protected is encrypted. The first embodiment of the present invention encrypts the specific object to be protected but may use a method for removing the part corresponding to the object information data to be protected among the compression data in order to prevent the breakage of encryption through hacking of a network.

The first embodiment of the present invention includes the communication module 104 that is connected to the encryption unit 103 and converts and sends out the encrypted compression data, that is, the compression digital image data encrypting only the specific object (encryption target object) into the packet data in order to send out to the outside. The communication module 104 may be a wireless communication unit in the embodiment of the present invention. An example of the wireless communication unit may include RF communication, Bluetooth, and a wireless LAN, etc. In addition to this, a wired communication unit may be included in the communication module 104 in the embodiment of the present invention. Further, the communication module 104 should also include a function of converting the encrypted compression data into transmittable packet data as described above, in addition to the communication unit.

The user may transmit the encrypted compression data to the network to be shared with other user and also directly store the encrypted compression data in his/her own photographing apparatus or his/her storage medium. Therefore, the photographing apparatus including the partial encryption function according to the first embodiment of the present invention may further include a data storage unit (not shown). The data storage unit may store the encrypted compression data as well as an encryption key data for decrypting the encrypted compression data for each user from the encryption unit 103, as described above. Therefore, the data storage unit may have a function that stores the encrypted compression image data as well as the encryption key data. The data storage unit may be a recording medium that includes an SDRAM existing in the photographing apparatus or a portable storage medium that includes a universal serial bus (USB), a smart media (SM), and a multimedia media card (MMC).

The first embodiment of the present invention may further store the encrypted compression data and the encryption data for decrypting the encrypted compression data as well as the user desired encryption target, that is, the object list data in the data storage unit. The user stores the encryption target object list in the data storage unit, in particular, the external data storage unit without storing the object list data to be encrypted in the photographing apparatus one by one to determine whether the encryption target object list exists in the external data storage unit by the encryption unit 103, thereby making it possible to update the encryption target object list stored in the encryption unit 103. The additional function of the data storage unit may also be included in the second to fourth embodiments to be described below.

The network photographing apparatus including the above-mentioned partial encryption function may be configured of different processors for each component, but the second embodiment of the present invention may be implemented using two processors. The apparatus diagram according to the second embodiment of the present invention is shown in FIG. 2. Hereinafter, the overlapped portions with the description of the first embodiment of the present invention will be omitted in the description of the second embodiment of the present invention.

Referring to FIG. 2, the network photographing apparatus including the partial encryption function according to the second embodiment of the present invention basically includes a photographing unit 200 and a decoder 201. In the second embodiment of the present invention, the photographing unit 200 and the decoder 201 are divided into different apparatuses. However, the decoder 201 may be embedded into the photographing unit 200 as in the first embodiment. In addition, the characteristics of the photographing unit 200 and the decoder 201 are the same as the description of the first embodiment.

In the second embodiment of the present invention, the first processor 202 includes an object information extracting unit 204. Therefore, the first processor 202 will store a program for a function of the object information extracting unit 204. Therefore, the first processor 202 serves to receive the digital image data, search objects, and generate the object information data, as described above. In addition, the first processor 201 serves to generate the object information data and transmits them to the second processor 203 to be described below.

In the second embodiment of the present invention, the second processor 203 is an apparatus that includes one or more function of the encryption unit 205, the image compression unit 206, and the communication module 207. Therefore, the second processor 203 receives the digital image data from the decoder 201 and converts the digital image into a type of the compression data format mentioned above, compares them with the object information data received from the first processor 202 and generates encrypted data by encrypting only a part of the compression data corresponding to the object information data to be encrypted among the received object information data, and performs a function of transmitting the generated compression data to the external network through the communication module 207.

The second processor 203 may further perform the function of storing and updating the object information or the encryption target object list data and the second processor 203 may include a data storage unit that may store the encrypted compression data or the encryption key data for decrypting the encrypted compression data as described above, and the data storage unit does not exist in the second processor 203 but may include the storage unit, such as the detachable SM, MMC, UMC, etc.

In the second embodiment of the present invention, the first and second processors 202 and 203 may have a plurality of communication interfaces to perform the above-mentioned functions. There may be each component that transmits and receives data in the apparatus, for example, the communication interface for transmitting and receiving data between the photographing unit 200, the decoder 201, and the processors 202 and 203. The second processor 203 including the communication module 207 may include the data output interface that can transmit and receive data to and from the external communication apparatus.

The second embodiment of the present invention is limited to each component of the present invention included in the first and second processors 202 and 203. However, in another embodiment of the present invention, one or more of the object information extracting unit 204, the encryption unit 205, the image compression unit 206, and the communication module 207 in each processor 202 and 203 may be installed in another processor. For example, differently with FIG. 2, the object information extracting unit 204 and the encryption unit 205 are included in the first processor 202 and the image compression unit 206 and the communication module 207 may be included in the second processor 203. In this case, in order to perform the functions of each component according to the first embodiment of the present invention, data can be transmitted and received through the above-mentioned plurality of communication interfaces.

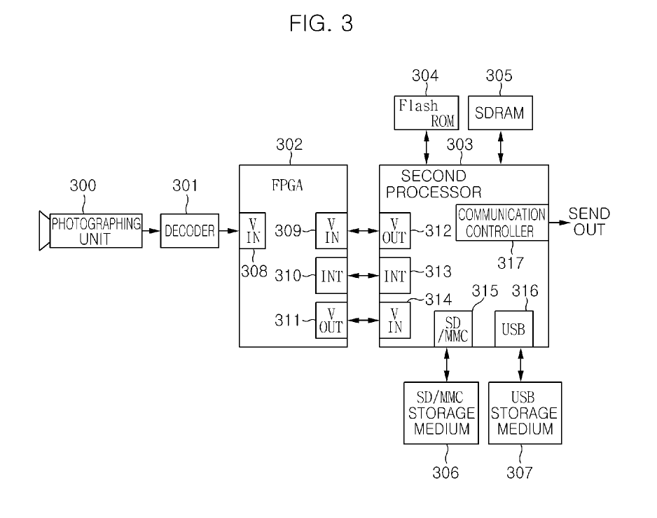

FIG. 3 shows a effective implementation example of a network photographing apparatus including a partial encryption function according to a third embodiment of the present invention described in FIG. 2. Also, the overlapped description will be omitted as described above.

Referring to FIG. 3, there are a photographing unit 300 and a decoder 301. The decoder 301 is connected to a field programmable gate array 302 (FPGA) as the first processor. The FPGA 302 is a semiconductor device that includes a programmable logic element and a programmable inner line. The programmable logic element may replicate and program AND, OR, XOR, NOT, and more sophisticated decoder or a function of a basic logic gate such as a combination function of a computing function. Most FPGAs include a memory element that includes a simple flip-flop or more complete memory block in a programmable logic element (referred to as a logic block in an FPGA manner). Although the speed is slow, since in the embodiment of the present invention speed is not important, the third embodiment of the present invention may select and use an FPGA 302 as the first processor.

The FPGA 302 and the decoder 301 are connected to each other through a first video input terminal 308. Through this, the FPGA 302 receives the digital image data from the decoder 301. The FPGA 302 serves to transmit the received digital image data to the second processor 303 through the first video out terminal 311 and at the same time, process the received digital image data and extract and generate the object information data. In addition, the FPGA 302 serves to transmit the generated object information data to the second processor 303 through the first communication interface 310.

The second processor 303 receives the digital image data through the second video input terminal 314 and generates the compression data, receives the object information through the second communication interface terminal 310 and compares it with the compression data. Only the object to be encrypted is encrypted through the function and the encrypted compression data are converted into packet data transmittable to the outside, which is in turn transmitted to the outside through a communication controller 317 (or communication module). The second processor 303 may further include a flash ROM 304 or an SDRAM 305 for storing at least one of the encryption target object list data, the image compression codec data, the encrypted compression data, the encryption key data for decrypting the encrypted compression data, and the encryption program. Further, the second processor 303 may include a terminal 316 that can be connected to the SD, a terminal 315 that can be connected to the MMC storage medium 306, and the USB storage medium 307 for storing the encrypted compression data or the encryption key data for decrypting the encrypted compression data externally. Similar to the second embodiment, in the third embodiment, each function may be changed to each other. This is because the FPGA 302 and the second processor 303 are connected to each other through the communication video input and output terminals to transmit and receive the digital image data or other transmittable data.

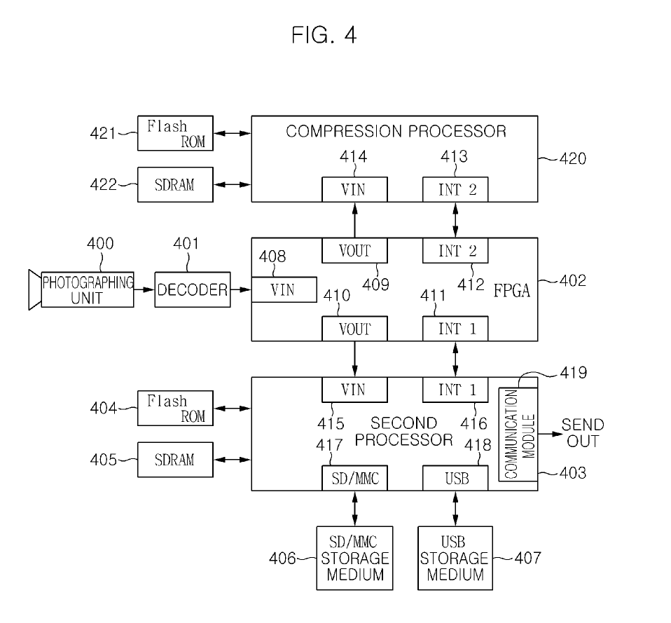

FIG. 4 is a effective apparatus diagram of the network photographing apparatus including a partial encryption function according to a fourth embodiment of the present invention. In the description of the fourth embodiment of the present invention, the description of the overlapped portions with the above-mentioned descriptions will also be omitted.

Referring to FIG. 4, the largest difference from the third embodiment of FIG. 3 is that the function corresponding to the image compression unit is devided in a separate processor, that is, a compression processor 420. In order to perform the image compression, the storage of the codec data and the storage or performance of the program for the image compression function can be achieved and thus, in order to perform the functions, a separate processor is added to reduce the load of the system. Therefore, the FPGA 402 will perform the function of the object information extracting unit, the second processor 403 will perform the function of the encryption unit and the communication module, and the compression processor 420 will perform the function of the image compression unit. In the fourth embodiment of the present invention, the compression processor 420 will perform a function to generate the compression data compressing the digital image data and the fact that the FPGA 402 and the second processor 403 can exchange each function was described in the second and third embodiments.

According to the fourth embodiment of the present invention, an FPGA 402, a second processor 403, and a compression processor 420 encrypt or remove the parts of the compressed data corresponding to the object information data to be encrypted by processing the digital image data generated passing through a photographing unit 400 and a decoder 401 to generate the encrypted compression data, thereby making it possible to send out the encrypted compression data to the outside through a communication module 419 or store them in external storage media 406 and 407. Video input terminals 408, 414, and 415, video output terminals 409 and 410, data transmitting and receiving terminals 411, 412, 413, and 416 (or communication interface), and external storage medium connecting terminals 417 and 418 can transmit and receive the digital image data or the above-mentioned data necessary to implement other embodiments of the present invention to and from each processor, internal storage media 404, 405, 421, and 422 that are connected to the processors to store the compression codec, the object list data to be encrypted, the encryption program, the encryption program, and programs for implementing other embodiments of the present invention, and a decoder 401.

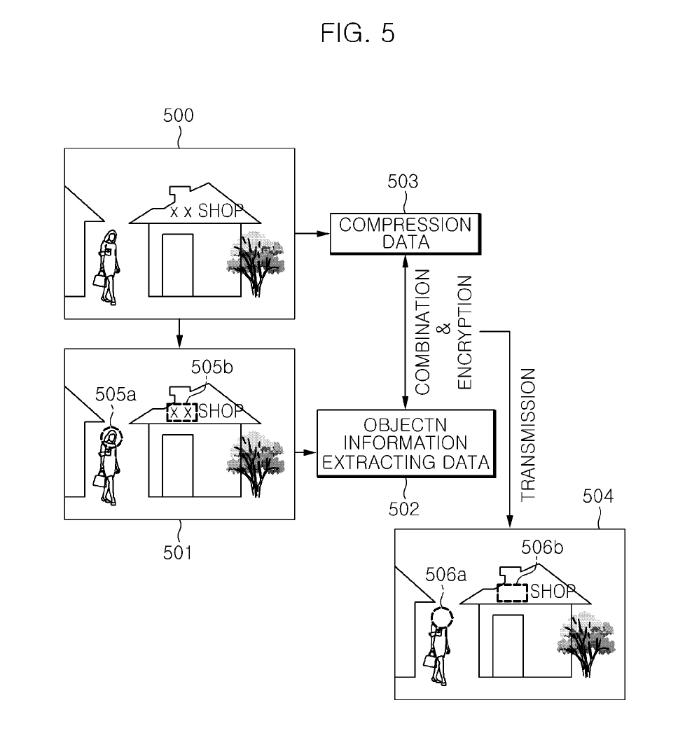

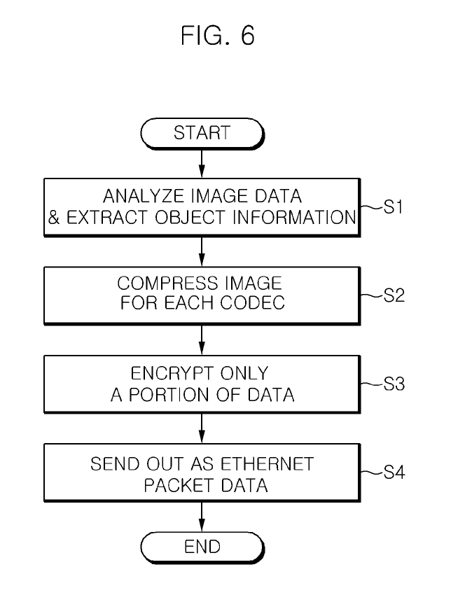

The network photographing method including the partial encryption function using the network photographing apparatus including the partial encryption function according to the above-mentioned first to fourth embodiments of the present invention and the implementation example thereof are shown in FIGS. 5 and 6. The description of FIG. 5 will be described with reference to the first embodiment.

Referring to FIG. 5, in the digital image data 500 that are first photographed and digitally processed, there are users, buildings, and trees. When the user wants to encrypt or remove a face or a company name of building, a case of adding the face of the user or the company name of building to the encryption target object list will be described.

When the digital image data 500 are transmitted to the object information extracting unit 101 through the photographing unit 101 and the decoder included in the photographing unit 100, the object information extracting unit 101 performs a step S1, analyzing the digital image data and detecting objects included in the digital image data. At step S1, the object information extracting unit 101 also compares the information on the detected object with the pre-stored object information data to generate the object information data extracting an object and transmit object information data 502 to the encryption unit 103. when the object information extracting unit 101 extracts the object information data 502, the image compression unit 102 performs step 2 that is compressing the digital image data according to the defined codec, and generating the compression data 503 and transmitting them to the encryption unit 103.

The encryption unit 103 receiving the compression data 503 and the object information data 502 compares the stored encryption target object list data with the received object information data 502. In FIG. 5, it is assumed that the user wants to encrypt a face object of a person (505a) and a character object 505b for a company name of building. Therefore, at step S3, the encryption unit 103 encrypts or removes a face object of a person 505a and the character object 505b for a company name of building, that is, combines and encrypts the object information data 502 and the compression data 503 by encrypting only the encryption target.

Finally, it can be known in the encrypted compression data 504 that the face object of a person is represented by the encryption or deleted object 506a and the object for the company name of building is represented by the encrypted or deleted object 506b. The encrypted compression data may again be decrypted for the encrypted object through the encryption key as described above or may be completely deleted so as not to be decrypted. At step S4, the communication module 104 converts the encrypted compression data 504 into the packet data and transmits them to the outside through a communication network. Further, the packet data or the encrypted compression data 504 may be stored in the data storage unit.

The first to fourth embodiments of the network photographing apparatus including the above-mentioned encryption function are used for description and will not be construed as limiting the claims of the present invention. Further, in addition to the foregoing embodiments, the equivalent inventions performing the same function as the present invention should be construed as being included in the scope of the present invention.

What is claimed is:

1. A network photographing apparatus having a partial encryption function, comprising:
an object information extracting unit that receives a digital image data from a photographing unit, analyzes objects included in the digital image data, and generates an object information data;
an image compressing unit that processes the digital image data into a compression data; and
an encryption unit that searches an encryption target object information data among the object information data received from the object information extracting unit and generates an encrypted compression data by encrypting only a part of the compression data, the part corresponding to the encryption target object information data.

2. The network photographing apparatus according to claim 1, wherein any of the objects includes at least one of predetermined regions of a person, object, building, color, shape, character, and image included in the digital image data.

3. The network photographing apparatus according to claim 1, wherein the object information data includes at least one of the position, size, range, color, and shape of the object and a name of an object identifying the object.

4. The network photographing apparatus according to claim 1, wherein the photographing unit comprises a decoder that converts photographed analog image signals into digital image data.

5. The network photographing apparatus according to claim 1, wherein the encryption unit further stores a list of the encryption target object information data for searching the encryption target object and updates the same in real time.

6. The network photographing apparatus according to claim 1, wherein the network photographing apparatus further comprises a communication module that receives the encrypted compression data from the encryption unit and converts the encrypted compression data into a packet data transmittable through an external communication network and sends out the converted packet data to the outside.

7. The network photographing apparatus according to claim 1, wherein the network photographing apparatus further comprises a data storage unit that is connected to the encryption unit and stores an encryption key data used to decrypt an encryption for the encrypted compression data or the encrypted compression data.

8. The network photographing apparatus according to claim 7, wherein the data storage unit is a detachable storage device that includes at least one of SM, MMC, and USB storage devices.

9. A network photographing apparatus having a partial encryption function, comprising:
a first processor that analyzes objects included in a digital image data received from a photographing unit and generates an object information data; and
a second processor that processes the digital image data into a compression data, searches encryption target object information data among the object information data received from the first processor and generates a encrypted compression data by encrypting only a part of the compression data, the part corresponding to the encryption target object information data.

10. The network photographing apparatus according to claim 9, wherein any of the objects includes at least one of predetermined regions of person, object, building, color, shape, character, and image included in the digital image data.

11. The network photographing apparatus according to claim 9, wherein the object information data includes at least one of the position, size, range, color, and shape of the object and a name of an object identifying the object.

12. The network photographing apparatus according to claim 9, wherein the photographing unit comprises a decoder that converts photographed analog image signals into digital image data.

13. The network photographing apparatus according to claim 9, wherein the second processor further stores a list of the encryption target object information data for searching the encryption target object and updates the same in real time.

14. The network photographing apparatus according to claim 9, wherein the second processor further comprises a communication module that converts the encrypted compression data into a packet data transmittable through an external communication network and sends out the converted packet data to the outside.

15. The network photographing apparatus according to claim 9, wherein the network photographing apparatus further comprises a data storage unit that is connected to the second processor and stores an encryption key data used to decrypt a encryption for the encrypted compression data or the encrypted compression data.

16. The network photographing apparatus according to claim 15, wherein the data storage unit is a detachable storage device that includes at least one of SM, MMC, and USB storage devices.

17. A network photographing method having a partial encryption function, comprising:
generating an object information data by analyzing objects included in a digital image data received from a photographing unit by an object information extracting unit;
processing the digital image data into a compression data by an image compression unit;
searching, by an encryption unit, encryption target object information data among the object information data received from the object information extracting unit; and
generating, by the encryption unit, a encrypted compression data by encrypting only a part of the compression data, the part corresponding to the encryption target object information data.

18. The network photographing method according to claim 17, wherein any of the objects includes at least one of predetermined regions of a person, object, building, color, shape, character, and image included in the digital image data.

19. The network photographing method according to claim 17, wherein the object information data includes at least one of the position, size, range, color, and shape of the object and a name of an object identifying the object.

20. The network photographing method according to claim 17, wherein the network photographing method further comprises receiving, by a communication module, the encrypted compression data from the encryption unit and converts the encrypted compression data into a packet data transmittable through an external communication network and sends out the converted packet data to the outside.
